(19) United States
(12) Patent Application Publication
(10) Pub. No.: US 2026/0004540 A1
(43) Pub. Date: Jan. 1, 2026

(54) METHOD AND SYSTEM FOR IMPROVING IMAGE ANALYSIS, AND COMPUTER READABLE STORAGE MEDIUM

(71) Applicant: HTC Corporation, Taoyuan City (TW)

(72) Inventors: Chang-Hua Wei, Taoyuan City (TW); Sheng-Cherng Lin, Taoyuan City (TW)

(73) Assignee: HTC Corporation, Taoyuan City (TW)

(21) Appl. No.: 18/760,053

(22) Filed: Jul. 1, 2024

(51) Int. Cl. G06V 10/22; G06T 3/4038; G06V 40/20; G10L 15/22

(52) U.S. Cl. CPC G06V 10/235; G06T 3/4038; G06V 40/28; G10L 15/22; G10L 2015/223

(57) ABSTRACT

The embodiments of the disclosure provide a method and system for improving image analysis, and a computer readable storage medium. The method includes: obtaining, by a front-end device, a plurality of first images and a user voice prompt; generating, by the front-end device, a target image based on the user voice prompt and the plurality of first images by performing at least one of following operations: identifying a region of interest from the plurality of first images based on a first gesture and generating the target image according to the region of interest; combining at least a part of the plurality of first images into a panorama image as the target image; and transmitting, by the front-end device, the target image and the user voice prompt to a back-end device.

### BACKGROUND

### 1. Field of the Invention

The present disclosure generally relates to a mechanism for improving image processing, in particular, to a method and system for improving image analysis, and a computer readable storage medium.

### 2. Description of Related Art

In modern society, it is quite common to request image analysis results from artificial intelligence (AI) models by providing them with images. However, while AI can acquire the necessary information through analyzing images, processing too many to-be-identified images will severely affect the efficiency of image analysis. Moreover, if the content of the images provided to AI is too complex, it will also affect the accuracy of image analysis.

Therefore, if the number of images provided to AI or informing AI in advance of the to-be-analyzed specific areas in the entire image, the efficiency and accuracy of image analysis would be improved.

### SUMMARY OF THE INVENTION

Accordingly, the disclosure is directed to a method and system for improving image analysis, and a computer readable storage medium, which may be used to solve the above technical problems.

The embodiments of the disclosure provide a method for improving image analysis. The method includes: obtaining, by a front-end device, a plurality of first images and a user voice prompt; generating, by the front-end device, a target image based on the user voice prompt and the plurality of first images by performing at least one of following operations: identifying a region of interest from the plurality of first images based on a first gesture and generating the target image according to the region of interest; combining at least a part of the plurality of first images into a panorama image as the target image; and transmitting, by the front-end device, the target image and the user voice prompt to a back-end device.

The embodiments of the disclosure provide a system for improving image analysis. The system includes a front-end device, wherein the front-end device performs: obtaining a plurality of first images and a user voice prompt; generating a target image based on the user voice prompt and the plurality of first images by performing at least one of following operations: identifying a region of interest from the plurality of first images based on a first gesture and generating the target image according to the region of interest; combining at least a part of the plurality of first images into a panorama image as the target image; and transmitting the target image and the user voice prompt to a back-end device.

The embodiments of the disclosure provide a computer readable storage medium, the computer readable storage medium recording an executable computer program, the executable computer program being loaded by a front-end device to perform steps of: obtaining a plurality of first images and a user voice prompt; generating a target image based on the user voice prompt and the plurality of first images by performing at least one of following operations: identifying a region of interest from the plurality of first images based on a first gesture and generating the target image according to the region of interest; combining at least a part of the plurality of first images into a panorama image as the target image; and transmitting the target image and the user voice prompt to a back-end device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a system for improving image analysis according to an embodiment of the disclosure.

FIG. 2 shows a flow chart of the method for improving image analysis according to an embodiment of the disclosure.

FIG. 3 shows a flow chart of the method for improving image analysis according to FIG. 2 and the first embodiment of the disclosure.

FIG. 4 shows a schematic diagram according to the first embodiment of the disclosure.

FIG. 5 shows an application scenario of determining the region of interest according to the first embodiment.

FIG. 6 shows a flow chart of the method for improving image analysis according to FIG. 2 and the second embodiment of the disclosure.

FIG. 7 shows an application scenario according to the second embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

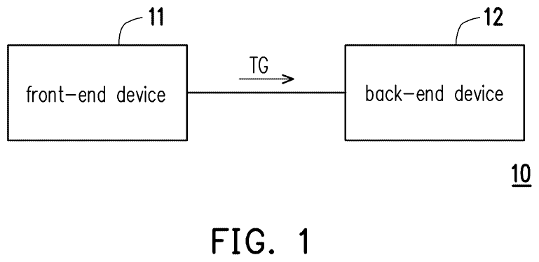

See FIG. 1, which shows a schematic diagram of a system for improving image analysis according to an embodiment of the disclosure.

In FIG. 1, the system 10 includes a front-end device 11 and a back-end device 12. In some embodiments, the front-end device 11 can be a smart device and/or computer device that is capable of obtaining images via, for example, capturing images via cameras (e.g., front cameras) and/or retrieving images from the associated storage spaces. In some embodiments, the back-end device 12 may be a computing device that can be used to perform the required computation (e.g., AI computation) in response to the request from the front-end device 11 and/or the user.

In some embodiments, the front-end device 11 can be a wearable device, such as a head mounted-display (HMD) and/or a pair of smart glasses for providing contents of reality services (e.g., augmented reality (AR) service, etc.). In one embodiment, the front-end device 11 may be a pair of AR glasses, but the disclosure is not limited thereto.

In one embodiment, the front-end device 11 may be disposed with elements such as a storage circuit, a processor, one or more microphone, and/or a camera.

The storage circuit may be one or a combination of a stationary or mobile random access memory (RAM), read-only memory (ROM), flash memory, hard disk, or any other similar device, and which records a plurality of modules and/or a program code that can be executed by the processor.

The processor may be coupled with the storage circuit, the microphone, and/or the camera. The processor may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In some embodiments, the back-end device 12 may also be disposed with elements such as a storage circuit and/or a processor. In one embodiment, the back-end device 12 may be used to perform intensive computation tasks (e.g., AI computations), and hence the computation capability of the associated processor may be more advanced than the processor in the front-end device 11, but the disclosure is not limited thereto. In some embodiments, the back-end device 12 may be a server (e.g., a cloud server), a computing center, a work station, or the like.

In some embodiments, the microphone on the front-end device 11 may be used to receive environment sound and/or voices from the user thereof. In one embodiment, the microphone on the front-end device 11 may be used to receive a user voice prompt from the user, wherein the user voice prompt may be used to control the front-end device 11 and/or the back-end device 12 to perform some specific functions required by the user.

For example, in the embodiments where the front-end device 11 is a pair of AR glasses worn by the user, the user may use, for example, a hand gesture to indicate a particular object shown in the AR content provided by the front-end device 11 and provide voice prompts such as “What color is this?”, “What is this?” as the user voice prompt, but the disclosure is not limited thereto. In the embodiment, the user may indicate the particular object via, for example, pointing to and/or circling the particular object, but the disclosure is not limited thereto.

In response to the received user voice prompt, the front-end device 11 may provide the images associated with the user voice prompt (e.g., the images captured during the user voice prompt is inputted) to the back-end device 12 for further image analysis. For example, in response to the user voice prompt of “What color is this?”, the back-end device 12 may perform a sematic analysis on this user voice prompt and accordingly perform the image analysis on the images received from the front-end device 11 to determine, for example, the color of the particular object indicated by the user. Next, the back-end device 12 may transmit the associated image analysis result to the front-end device 11 for the front-end device 11 to show the image analysis result to the user, but the disclosure is not limited thereto.

In one embodiment, the front-end device 11 may be disposed with the corresponding outputting elements for showing/outputting the image analysis result, such as a speaker, a projector, a display, etc.

In one embodiment, the back-end device 12 may perform the above sematic analysis and/or image analysis by using an AI model, but the disclosure is not limited thereto.

However, if the number of images associated with the user voice prompt is too many and/or the contents in each received image is too complex, the efficiency and/or accuracy of the back-end device 12 performing the image analysis may be unsatisfying.

Therefore, the embodiments of the disclosure provide a method for improving image analysis, which can be used to solve the above problem and improve the efficiency and/or accuracy of image analysis.

In the embodiments of the disclosure, the processor of the front-end device 11 may access the modules and/or the program code stored in the storage circuit of the front-end device 11 to implement the method for improving image analysis provided in the disclosure, which would be further discussed in the following.

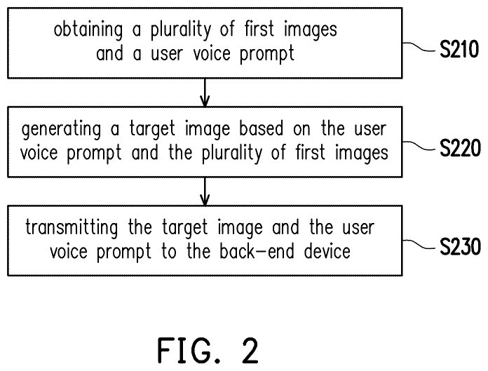

See FIG. 2, which shows a flow chart of the method for improving image analysis according to an embodiment of the disclosure. The method of this embodiment may be executed by the front-end device 11 in FIG. 1, and the details of each step in FIG. 2 will be described below with the components shown in FIG. 1.

In step S210, the front-end device 11 obtains a plurality of first images and a user voice prompt. In various embodiments, step S210 can be performed in different ways.

In one embodiment, the user may trigger the front-end device 11 to perform an image capturing operation to capture a plurality of images by providing a specific voice prompt or inputting a specific hardware triggering operation to the front-end device 11, wherein the specific voice prompt and the specific hardware triggering operation are used for triggering the image capturing operation.

In one embodiment, the specific voice prompt may be one or more of the voice prompts whose sematic substantially corresponding to the intentions of capturing images, such as “Capturing images”, “Activating camera”, “Activating computer vision”, or the like, but the disclosure is not limited thereto. In this case, once the front-end device 11 determines that the specific voice prompt has been detected, the front-end device 11 may accordingly perform the image capturing operation to capture the plurality of images.

In one embodiment, the front-end device 11 may be disposed with hardware elements (e.g., buttons) specifically used for capturing images. In this case, once one or more of these hardware elements has been triggered (e.g., pressed and/or touched), the front-end device 11 may determine that the specific hardware triggering operation has been detected and accordingly perform the image capturing operation to capture the plurality of images, but the disclosure is not limited thereto.

In the embodiments where the front-end device 11 captures the plurality of images by the camera thereon (e.g., the front camera), the camera may be in the stand-by mode and/or deactivated mode before the specific voice prompt or the specific hardware triggering operation is detected. In this case, the front-end device 11 may activate the camera in response to determining that the specific voice prompt or the specific hardware triggering operation is detected, and switch the camera back to the stand-by mode and/or deactivated mode after determining that the required images have been captured. Accordingly, the power consumption of the front-end device 11 can be reduced.

In one embodiment, after the front-end device 11 has captured the plurality of images in response to the specific voice prompt or the specific hardware triggering operation, the front-end device 11 may extract a plurality of second images corresponding to the user voice prompt among the plurality of images as the plurality of first images considered in step S210.

In one embodiment, the front-end device 11 may determine a duration where the user voice prompt occurs and accordingly determine the plurality of second images, wherein the plurality of second images are captured within the duration.

For example, assuming that the duration where the user voice prompt occurs is between timing points T1 and T2 (e.g., T2 is later than T1), the front-end device 11 may determine the images whose timestamp (e.g., the timing point where the image is captured) is between the timing points T1 and T2 as the considered second images, but the disclosure is not limited thereto. In some embodiments, the front-end device 11 may include more images into the considered second images, such as the images whose timestamps is before the timing point T1 by a first predetermined time and/or the images whose timestamps is later than the timing point T2 by a second predetermined time, but the disclosure is not limited thereto.

In another embodiment, the camera can be maintained as activated and continuously buffering the captured images. In this case, the front-end device 11 may determine whether the sematic of the user voice prompt involves an image analysis intention, such as a question regarding the visual contents shown to the user (e.g., “What is this?”, “What color is this?”, etc.).

In the embodiment, in response to determining that the semantic of the user voice prompt involves the image analysis intention, the front-end device 11 may extract a plurality of second images corresponding to the user voice prompt among the plurality of images as the plurality of first images considered in step S210. For example, the front-end device 11 may determine the duration where the user voice prompt occurs and accordingly determine the plurality of second images. The details associated with determining the second images may be referred to the above embodiments, which would not be repeated herein.

In the embodiment, since the user can directly provide the user voice prompt without providing the specific voice prompt or the specific hardware triggering operation, the operation would be more intuitive, but the disclosure is not limited thereto.

In the embodiments of the disclosure, the first images in step S210 may be understood as the images corresponding to the user voice prompt, but the disclosure is not limited thereto.

In step S220, the front-end device 11 generates a target image TG based on the user voice prompt and the plurality of first images. In various embodiments, step S220 may be performed in different ways, which would be discussed with a first embodiment and a second embodiment.

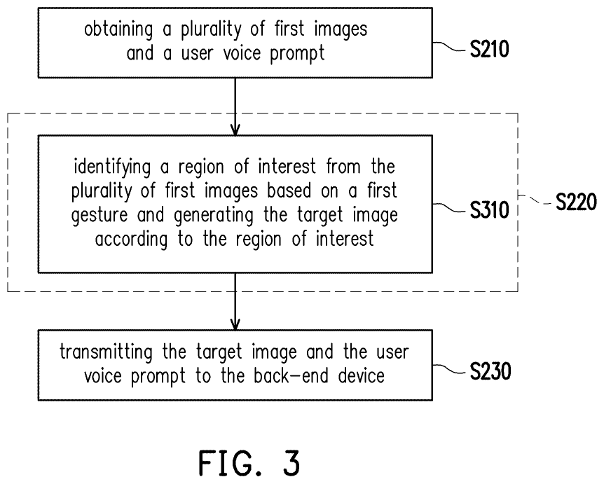

See FIG. 3, which shows a flow chart of the method for improving image analysis according to FIG. 2 and the first embodiment of the disclosure.

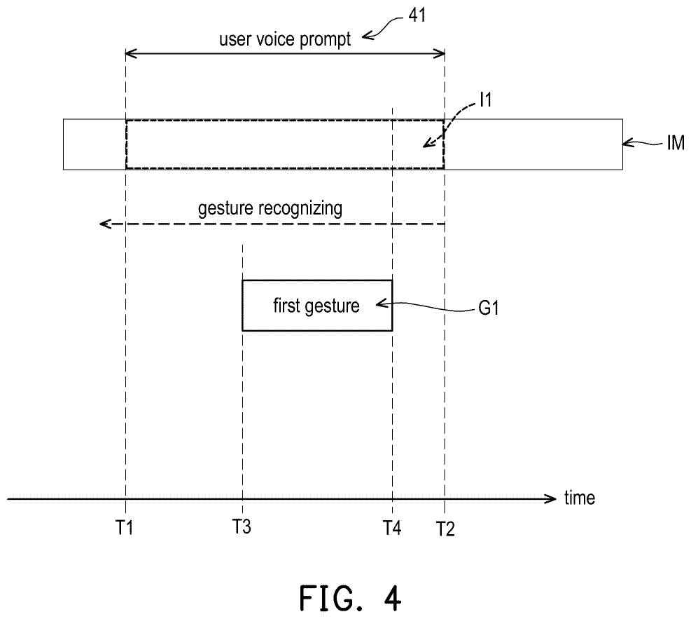

In FIG. 3, the front-end device 11 may perform step S310 to implement step S220. In step S310, the front-end device 11 identifies a region of interest (ROI) from the plurality of first images based on a first gesture and generates the target image TG according to the ROI. For better understanding, FIG. 4 would be used as an example, but the disclosure is not limited thereto.

See FIG. 4, which shows a schematic diagram according to the first embodiment of the disclosure. In FIG. 4, it is assumed that the front-end device 11 captures a plurality of images IM in response to, for example, the specific voice prompt or the specific hardware triggering operation, and the user voice prompt 41 occurs between the timing points T1 and T2 (e.g., the user initiates the user voice prompt 41 at the timing point T1 and finishes the user voice prompt 41 at the timing point T2). In this case, the front-end device 11 may determine, among the images IM, the images captured between the timing points T1 and T2 as the considered first images I1, but the disclosure is not limited thereto.

Next, the front-end device 11 may recognize the gesture (e.g., a hand gesture) from the plurality of first images I1 and determine the gesture recognized from the plurality of first images I1 as the first gesture G1. In FIG. 4, assuming that a gesture initiated from the timing point T3 and finished at the timing point T4 has been recognized, the front-end device 11 may determine this gesture as the first gesture G1, but the disclosure is not limited thereto.

In various embodiments, the first gesture G1 may be, for example, the user tapping, circling, and/or swiping across a particular object/region (which may be physical or virtual) within the visual content (e.g., AR content) shown to the user, but the disclosure is not limited thereto.

Next, the front-end device 11 may determine a reference image among the plurality of first images I1.

In the embodiment, the front-end device 11 may determine a plurality of gesture images corresponding to the first gesture G1 among the plurality of first images I1 and select one of the plurality of gesture images as the reference image.

In FIG. 4, the front-end device 11 may regard the first images I1 captured between the duration where the first gesture G1 occurs (e.g., the duration between the timing points T3 and T4) as the considered gesture images, but the disclosure is not limited thereto.

In this case, the front-end device 11 may select one of the plurality of gesture images as the reference image.

In one embodiment, the selected one of the plurality of gesture images may correspond to a first timing point where the first gesture G1 finishes. In FIG. 4, since the first gesture G1 is finished at the timing point T4, the front-end device 11 may select the gesture image captured at the timing point T4 (i.e., the first image I1 captured at the timing point T4) as the considered reference image, but the disclosure is not limited thereto.

In other embodiments, the front-end device 11 may alternatively select the gesture image captured at any desired timing point between the timing points T3 and T4 as the considered reference image, but the disclosure is not limited thereto.

In another embodiment, the selected one of the plurality of gesture images may correspond to a second timing point where a motion data associated with a user indicates that the user has performed a selecting operation.

In one embodiment, the user may wear a specific wearable device (e.g., a smart ring and/or a smart wrist band) on, for example, the hand or finger thereof, and the motion data (e.g., the inertial measurement unit (IMU) data) may be provided by the motion detection circuit (e.g., the IMU) on the specific wearable device, wherein the motion data may characterize the movement of the user, but the disclosure is not limited thereto.

In one embodiment, in response to determining that the motion data indicates that the user has performed a selection operation (e.g., a tapping operation or the like) in the duration where the first gesture G1 occurs, the front-end device 11 may determine the timing point where the selection operation is detected as the second timing point, and determine the gesture image captured at the second timing point as the considered reference image, but the disclosure is not limited thereto.

In some embodiments, the front-end device 11 may select more from the gesture images as the considered reference images for further processing/analysis, but the disclosure is not limited thereto.

After determining the reference image, the front-end device 11 may determine a region indicated by the first gesture G1 within the reference image as the ROI considered in step S310.

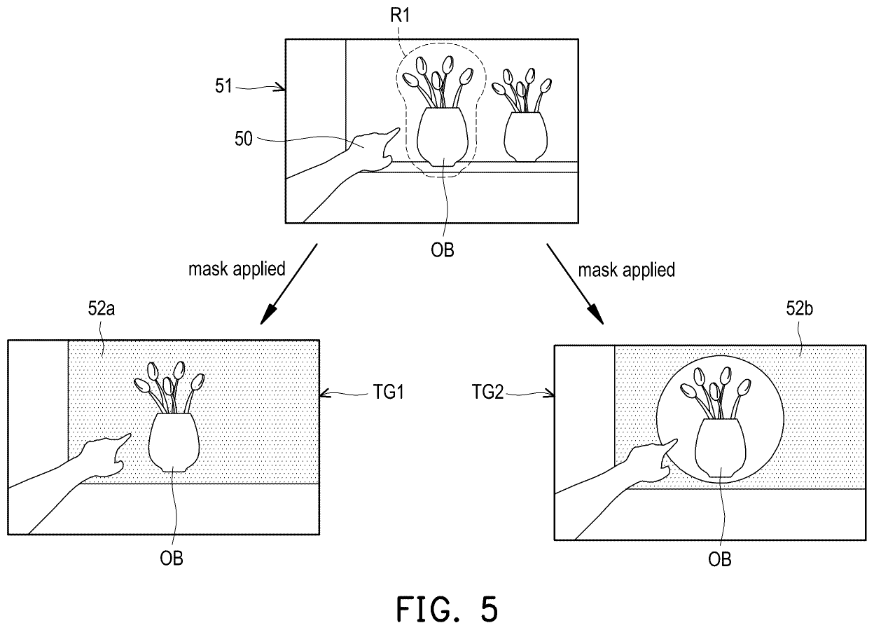

See FIG. 5, which shows an application scenario of determining the ROI according to the first embodiment.

In the embodiment, it is assumed that the reference image 51 has the content shown in FIG. 5. In the reference image 51, it can be seen that the user's hand 50 is pointing to a particular object OB (e.g., a vase), wherein the status of the user's hand 50 may be understood as corresponding to a specific instant of the first gesture G1.

In this case, the front-end device 11 may analyse the whole first gesture G1 to determine that the user intends to indicate/select/highlight the object OB by using the first gesture G1 (e.g., circling the object OB). In this case, the front-end device 11 may determine the region R1 indicated by the first gesture G1 (e.g., the region circled by the user) within the reference image 51 as the ROI, but the disclosure is not limited thereto.

In one embodiment, the front-end device 11 may detect a continuous moving track formed by the continuous movement of the user's hand 50 and accordingly determine the region R1. For example, the front-end device 11 may extract a part of the continuous moving track that substantially forms an enclosed region as the region R1, but the disclosure is not limited thereto.

After determining the required ROI, the front-end device 11 may accordingly generate the target image TG.

In FIG. 5, the front-end device 11 may determine a mask based on the ROI (e.g., the region R1) and combine the mask with the reference image 51 into the target image TG.

For example, the mask determined based on the ROI may be the mask 52a, which can be used to, for example, emphasize the region R1. In this case, the front-end device 11 may combine the mask 52a with the reference image 51 into the target image TG1 via, for example, overlaying the mask 52a onto the reference image 51, such that the object OB can be emphasized in the target image TG1, but the disclosure is not limited thereto.

For another example, the mask determined based on the ROI may be the mask 52b, which can be also used to, for example, emphasize the region R1. In this case, the front-end device 11 may combine the mask 52b with the reference image 51 into the target image TG2 via, for example, overlaying the mask 52b onto the reference image 51, such that the object OB can be emphasized in the target image TG2, but the disclosure is not limited thereto.

In a second embodiment, the front-end device 11 may generate the target image TG in a way different from the first embodiment.

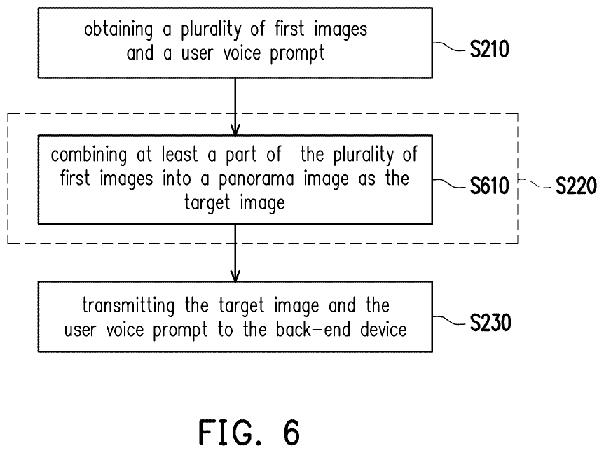

See FIG. 6, which shows a flow chart of the method for improving image analysis according to FIG. 2 and the second embodiment of the disclosure.

In FIG. 6, the front-end device 11 may perform step S610 to implement step S220. In step S610, the front-end device 11 combines at least a part of the plurality of first images I1 into a panorama image as the target image TG.

In different embodiments, the front-end device 11 may combine all of the plurality of first images I1 into the panorama image or merely combine some of the plurality of first images I1 into the panorama image, but the disclosure is not limited thereto.

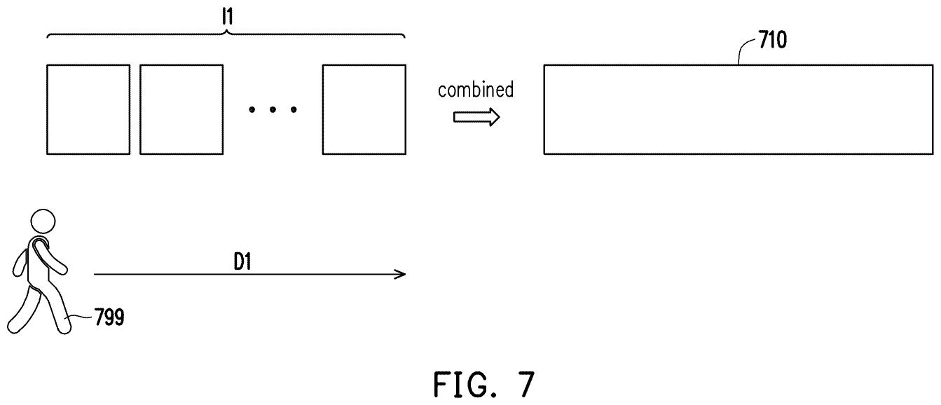

See FIG. 7, which shows an application scenario according to the second embodiment.

In FIG. 7, it is assumed that the user 799 wearing the front-end device 11 (e.g., the AR glasses) is in a place where numerous objects (e.g., fruits/vegetables in a market and/or books in a library) are listed in, for example, a wide container (e.g., a wide refrigerator or shelf) in front of the user 799, and the user 799 wants to find a particular object (e.g., an apple) among the numerous objects in the wide container.

In this case, the user 799 may provide the user voice prompt for characterizing this intention (e.g., “Where is the apple?”, “Find the apple”, or the like) and moving along a direction D1 across the wide container, such that the front-end device 11 may obtain the corresponding first images I1, and the procedure of obtaining the first images I1 may be referred to the above embodiments (e.g., the descriptions associated with FIG. 4), which would not be repeated herein.

In the embodiment, the first images I1 may be understood as the images corresponding to the user voice prompt, but the disclosure is not limited thereto.

Next, the front-end device 11 may combine the plurality of first images I1 into a panorama image 710. For example, the front-end device 11 may splice/stitch the plurality of first images I1 based on any conventional way of generating a panorama image, but the disclosure is not limited thereto.

After generating the panorama image 710, the front-end device 11 may regard the panorama image 710 as the target image TG, but the disclosure is not limited thereto.

After determining the target image TG (e.g., the target image TG1, TG2, and/or panorama image 710), the front-end device 11 transmits the target image TG and the user voice prompt to the back-end device 12 in step S230.

In one embodiment, the back-end device 12 can perform an image analysing operation on the target image TG based on the user voice prompt.

In the embodiment where the back-end device 12 receives the target image TG1 and/or TG2, since the number of the to-be-analysed image is significantly reduced and the content in the to-be-analysed image has been simplified by the mask 52a or 52b, the efficiency and accuracy of the back-end device 12 performing the image analysing operation can be improved.

Likewise, in the embodiment where the back-end device 12 receives the panorama image 710 as the target image TG, since the number of the to-be-analysed image is significantly reduced, the efficiency and accuracy of the back-end device 12 performing the image analysing operation can be also improved.

In one embodiment, the back-end device 12 may transmit the associated image analysis result to the front-end device 11 for the front-end device 11 to show the image analysis result to the user.

For example, in the embodiment where the target image TG is the target image TG1 or TG2 and the user voice prompt is “What is this?”, the corresponding image analysis result provided by the front-end device 11 may be, for example, “This is a vase.” or the like. In the embodiment, the image analysis result may be presented by the outputting elements (e.g., a speaker, a display, a projector, etc.) of the front-end device 11, but the disclosure is not limited thereto.

The disclosure further provides a computer readable storage medium for executing the method for improving image analysis. The computer readable storage medium is composed of a plurality of program instructions (for example, a setting program instruction and a deployment program instruction) embodied therein. These program instructions can be loaded into the front-end device 11 and/or the back-end device 12 and executed by the same to execute the method for improving image analysis and the functions of the front-end device 11 and/or the back-end device 12 described above.

In summary, the embodiments of the disclosure provide a solution for the front-end device to reduce the number of the to-be-analysed image and/or simplify the content in the to-be-analysed image, which improve the efficiency and accuracy of the image analysing operation performed by the back-end device.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for improving image analysis, comprising:
obtaining, by a front-end device, a plurality of first images and a user voice prompt;
generating, by the front-end device, a target image based on the user voice prompt and the plurality of first images by performing at least one of following operations:
identifying a region of interest from the plurality of first images based on a first gesture and generating the target image according to the region of interest;
combining at least a part of the plurality of first images into a panorama image as the target image; and
transmitting, by the front-end device, the target image and the user voice prompt to a back-end device.

2. The method according to claim 1, wherein obtaining the plurality of first images comprises:
in response to determining that a specific voice prompt or a specific hardware triggering operation has been detected, capturing, by the front-end device, a plurality of images, wherein the specific voice prompt and the specific hardware triggering operation are used for triggering an image capturing operation; and
extracting, by the front-end device, a plurality of second images corresponding to the user voice prompt among the plurality of images as the plurality of first images.

3. The method according to claim 2, wherein extracting the plurality of second images corresponding to the user voice prompt among the plurality of images as the plurality of first images comprises:
determining, by the front-end device, a duration where the user voice prompt occurs and accordingly determining the plurality of second images, wherein the plurality of second images are captured within the duration.

4. The method according to claim 1, wherein obtaining the plurality of first images comprises:
continuously buffering, by the front-end device, a plurality of images captured by the front-end device;
in response to determining that a semantic of the user voice prompt involves an image analysis intention, extracting, by the front-end device, a plurality of second images corresponding to the user voice prompt among the plurality of images as the plurality of first images.

5. The method according to claim 4, wherein extracting the plurality of second images corresponding to the user voice prompt among the plurality of images as the plurality of first images comprises:
determining, by the front-end device, a duration where the user voice prompt occurs and accordingly determining the plurality of second images, wherein the plurality of second images are captured within the duration.

6. The method according to claim 1, wherein identifying the region of interest from the plurality of first images based on the first gesture comprising:
determining a gesture recognized from the plurality of first images as the first gesture;
determining a reference image among the plurality of first images;
determining a region indicated by the first gesture within the reference image as the region of interest.

7. The method according to claim 6, wherein determining the reference image among the plurality of first images comprising:
determining a plurality of gesture images corresponding to the first gesture among the plurality of first images and selecting one of the plurality of gesture images as the reference image.

8. The method according to claim 7, wherein the one of the plurality of gesture image corresponds to a first timing point where the first gesture finishes or corresponds to a second timing point where a motion data associated with a user indicates that the user has performed a selecting operation.

9. The method according to claim 6, wherein generating the target image according to the region of interest comprises:
determining a mask based on the region of interest; and
combining the mask with the reference image into the target image.

10. The method according to claim 1, further comprising:
performing, by the back-end device, an image analysing operation on the target image based on the user voice prompt.

11. A system for improving image analysis, comprising:
a front-end device, performing:
obtaining a plurality of first images and a user voice prompt;
generating a target image based on the user voice prompt and the plurality of first images by performing at least one of following operations:
identifying a region of interest from the plurality of first images based on a first gesture and generating the target image according to the region of interest;
combining at least a part of the plurality of first images into a panorama image as the target image; and
transmitting the target image and the user voice prompt to a back-end device.

12. The system according to claim 11, wherein the front-end device performs:
in response to determining that a specific voice prompt or a specific hardware triggering operation has been detected, capturing a plurality of images, wherein the specific voice prompt and the specific hardware triggering operation are used for triggering an image capturing operation; and
extracting a plurality of second images corresponding to the user voice prompt among the plurality of images as the plurality of first images.

13. The system according to claim 12, wherein the front-end device performs:
determining a duration where the user voice prompt occurs and accordingly determining the plurality of second images, wherein the plurality of second images are captured within the duration.

14. The system according to claim 11, wherein the front-end device performs:
continuously buffering a plurality of images captured by the front-end device;
in response to determining that a semantic of the user voice prompt involves an image analysis intention, extracting a plurality of second images corresponding to the user voice prompt among the plurality of images as the plurality of first images.

15. The system according to claim 11, wherein the front-end device performs:
determining a gesture recognized from the plurality of first images as the first gesture;
determining a reference image among the plurality of first images;
determining a region indicated by the first gesture within the reference image as the region of interest.

16. The system according to claim 15, wherein the front-end device performs:
determining a plurality of gesture images corresponding to the first gesture among the plurality of first images and selecting one of the plurality of gesture images as the reference image.

17. The system according to claim 16, wherein the one of the plurality of gesture image corresponds to a first timing point where the first gesture finishes or corresponds to a second timing point where a motion data associated with a user indicates that the user has performed a selecting operation.

18. The system according to claim 17, wherein the front-end device performs:
determining a mask based on the region of interest; and
combining the mask with the reference image into the target image.

19. The system according to claim 11, further comprising the back-end device, wherein the back-end device performs an image analysing operation on the target image based on the user voice prompt.

20. A non-transitory computer readable storage medium, the computer readable storage medium recording an executable computer program, the executable computer program being loaded by a front-end device to perform steps of:
obtaining a plurality of first images and a user voice prompt;
generating a target image based on the user voice prompt and the plurality of first images by performing at least one of following operations:
identifying a region of interest from the plurality of first images based on a first gesture and generating the target image according to the region of interest;
combining at least a part of the plurality of first images into a panorama image as the target image; and
transmitting the target image and the user voice prompt to a back-end device.
